(19) United States
(12) Patent Application Publication
(10) Pub. No.: US 2024/0408772 A1
(43) Pub. Date: Dec. 12, 2024

(54) TIP-WRIST DEVICE AND ROBOT ARM APPARATUS

(71) Applicant: SONY GROUP CORPORATION, TOKYO (JP)

(72) Inventor: KIYOKAZU MIYAZAWA, TOKYO (JP)

(21) Appl. No.: 18/702,154

(22) PCT Filed: Sep. 8, 2022
(86) PCT No.: PCT/JP2022/033752

§ 371 Date: Apr. 17, 2024

(30) Foreign Application Priority Data
Oct. 28, 2021 (JP) 2021-176940

(51) Int. Cl. B25J 17/02

(52) U.S. Cl. CPC B25J 17/0283

(57) ABSTRACT

A tip-wrist device according to an embodiment of the present disclosure includes: a first actuator that uses a Yaw axis as its rotation axis; a second actuator that uses a Pitch axis as its rotation axis; a third actuator that uses a Roll axis as its rotation axis; and a torque transmitter. The first actuator, the second actuator, and the third actuator are disposed from an elbow side toward a hand side in this order. The torque transmitter causes, as the second actuator is driven, torque to occur that causes the third actuator to use, as its rotation axis, and rotate around a virtual axis that is parallel to the Pitch axis.

### TECHNICAL FIELD

The present disclosure relates to a tip-wrist device and a robot arm apparatus.

### BACKGROUND ART

Robots have been started to be introduced in workplaces in place of human workers along with reductions in working population. By taking into account workability of a robot, it is important that a compact wrist joint be formed (for example, see PTL 1).

### CITATION LIST

### Patent Literature

PTL 1: Japanese Unexamined Patent Application Publication No. 2015-85412

### SUMMARY OF THE INVENTION

As a configuration of a wrist joint of a serial link manipulator, a Yaw-Pitch-Yaw configuration having a compact hand-tip position where a joint position is not offset has been adopted in many cases. However, there has been such an issue in the Yaw-Pitch-Yaw configuration that the configuration easily falls into a singular posture where, in a case where a Pitch axis is set to 0 degrees, Yaw axes are aligned in a straight line, and a joint angle of the Yaw axes is not uniquely determined. Therefore, it is desirable to provide a tip-wrist device and a robot arm apparatus each having such a compact configuration that rarely falls into such a singular posture as described above and a collision in an ambient environment or with an object, for example, rarely occurs.

A tip-wrist device according to an embodiment of the present disclosure includes: a first actuator that uses a Yaw axis as its rotation axis; a second actuator that uses a Pitch axis as its rotation axis; a third actuator that uses a Roll axis as its rotation axis; and a torque transmitter. The first actuator, the second actuator, and the third actuator are disposed from an elbow side toward a hand side in this order. The first actuator causes the second actuator to use, as its rotation axis, and rotate around the Yaw axis. The third actuator causes a hand device to use, as its rotation axis, and rotate around the Roll axis. The torque transmitter causes, as the second actuator is driven, torque to occur that causes the third actuator to use, as its rotation axis, and rotate around a virtual axis that is parallel to the Pitch axis.

A robot arm apparatus according to an embodiment of the present disclosure includes the tip-wrist device described above.

As the second actuator provided between the first actuator and the third actuator is driven in the tip-wrist device and the robot arm apparatus according to the embodiment of the present disclosure, torque that causes the third actuator to use, as its rotation axis, and rotate around a virtual axis that is parallel to the Pitch axis is caused to occur. Thereby, a compact device size is achieved, compared with a case where the second actuator is disposed on the Roll axis. Furthermore, applying such a three-axis configuration makes it possible that such a singular point that occurs in a case where a two-axis configuration such as a Yaw-Pitch-Yaw configuration is applied rarely occurs.

### BRIEF DESCRIPTION OF DRAWING

FIG. 1 is a diagram illustrating a perspective configuration example of a robot arm apparatus according to an embodiment of the present disclosure.

FIG. 2 is a diagram illustrating a plane configuration example of a tip-wrist device illustrated in FIG. 1.

FIG. 3 is a diagram illustrating an exploded perspective configuration example of the tip-wrist device illustrated in FIG. 1.

FIG. 4 is a diagram illustrating a situation where the tip-wrist device illustrated in FIG. 1 is caused to take a −90° posture.

FIG. 5 is a diagram illustrating a situation where the tip-wrist device illustrated in FIG. 1 is caused to take a 0° posture.

FIG. 6 is a diagram illustrating a situation where the tip-wrist device illustrated in FIG. 1 is caused to take a +90° posture.

FIG. 7 is a diagram illustrating, in an enlarged manner, an elbow device illustrated in FIG. 1.

FIG. 8 is a diagram illustrating a perspective configuration example of a robot device provided with the robot arm apparatus illustrated in FIG. 1.

### MODES FOR CARRYING OUT THE INVENTION

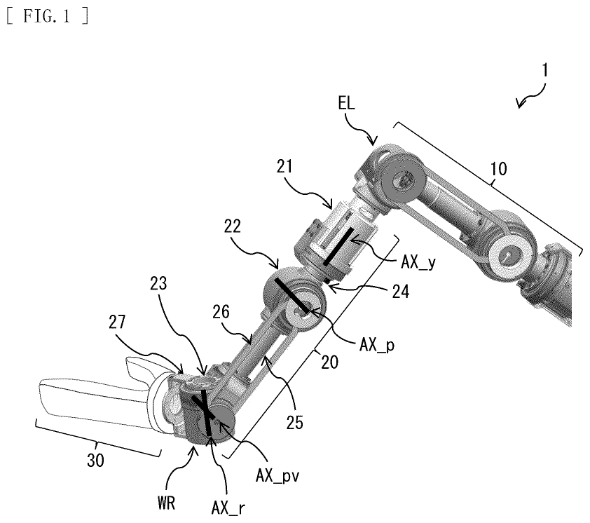

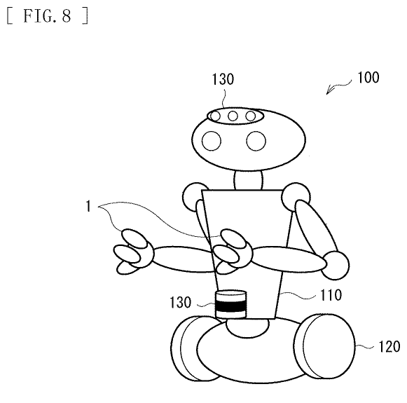

In the following, an embodiment of the present disclosure will be described in detail with reference to the drawings. It is to be noted that the embodiment described below is a specific example of the present disclosure, and the present disclosure is not limited to the following embodiment. In addition, the arrangement, dimensions, dimension ratios, and the like of components in the present disclosure are not limited to the embodiment illustrated in each drawing. It is to be noted that the description will be given in the following order.
1. Background
2. Embodiment (FIGS. 1 to 7)
3. Modification Examples
4. Application Example (FIG. 8)

### 1. BACKGROUND

Currently, reductions in working population are advancing due to negative effects of a low birthrate and a high aging rate in Japan, and, in its industries, there are severe shortages in population and labor in eating and drinking places and nursing facilities in particular, for example, resulting in big social issues. In such a social background as described above, collaborative robots are expected to actively manipulate objects in living spaces for persons. To achieve coexistence of a person and a robot in an identical space, it is necessary to secure not only working capability of the robot, but also safety to prevent the person and those in an environment from being damaged.

In a case where it is considered a space where a robot is able to work, having a wider movable joint angle of a robot arm and having a compact robot arm main body allow the robot to carry out a work while avoiding a collision in an ambient environment or with an object, for example, improving workability of the robot. In a case where a certain object is about to be grasped from among a group of various objects placed on a table, in particular, it is important that a movable range of a joint near a hand tip be wider and a size of a hand-tip joint itself be compact. Even in a case where it is not possible to finely adjust a position and a posture at a hand tip, there is a possibility that it is possible to use a joint on an upper arm to continue a work, for example. However, causing an upper arm to move may lead to such issues that it has to take into account a collision in an environment, consumption energy, and a speed of carrying out a task, for example.

To dispose a wrist joint in a compact manner, such a three-axis configuration that rotation axes are disposed in an order of a Yaw axis, a Pitch axis, and a Yaw axis in many cases. An actuator is generally formed longer in axial directions, and, in a case where a three-axis configuration is applied, a size of the actuator itself may be one factor of making application of a three-axis configuration difficult. Applying such a configuration, as a Yaw axis-Pitch axis-Yaw axis configuration, that it is possible to dispose two actuators in joint directions of a robot arm makes it possible to successfully dispose a size of the actuators themselves inside a structure of the robot arm, making it possible to make a joint itself compact. However, such a Yaw axis-Pitch axis-Yaw axis configuration, where there are two Yaw axes with a Pitch axis interposed, brings an issue of easily falling into a singular point (i.e., a joint posture is not uniquely determined).

Then, the inventors of the present application have applied a Yaw axis-Pitch axis-Roll axis configuration to achieve a three-axis configuration in a tip wrist of a robot arm to propose such a robot arm that has a compact configuration and that rarely falls into a singular point.

### 2. EMBODIMENT

FIG. 1 illustrates a perspective configuration example of a robot arm apparatus 1 according to an embodiment of the present disclosure. Note that a Yaw axis AX_y, a Pitch axis AX_p, a virtual Pitch axis AX_pv, and a Roll axis AX_y illustrated in FIG. 1 are provided for purpose of description, and represent no actual axes. The robot arm apparatus 1 according to the present embodiment is a device that functions as a manipulator in a robot device. The robot arm apparatus 1 includes an elbow device 10, a tip-wrist device 20, and a hand device 30, as illustrated in FIG. 1, for example.

The elbow device 10 is a device coupled to a main body in the robot device. The tip-wrist device 20 is a device coupled to the elbow device 10. A section at which the elbow device 10 and the tip-wrist device 20 are coupled to each other corresponds to an elbow section EL in the robot arm apparatus 1. The hand device 30 is a device coupled to the tip-wrist device 20. A section at which the tip-wrist device 20 and the hand device 30 are coupled to each other corresponds to a wrist section WR in the robot arm apparatus 1.

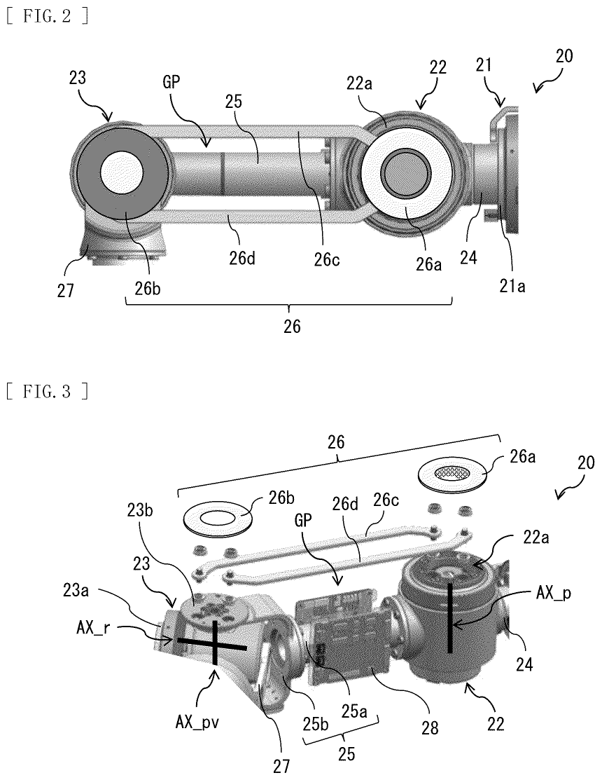

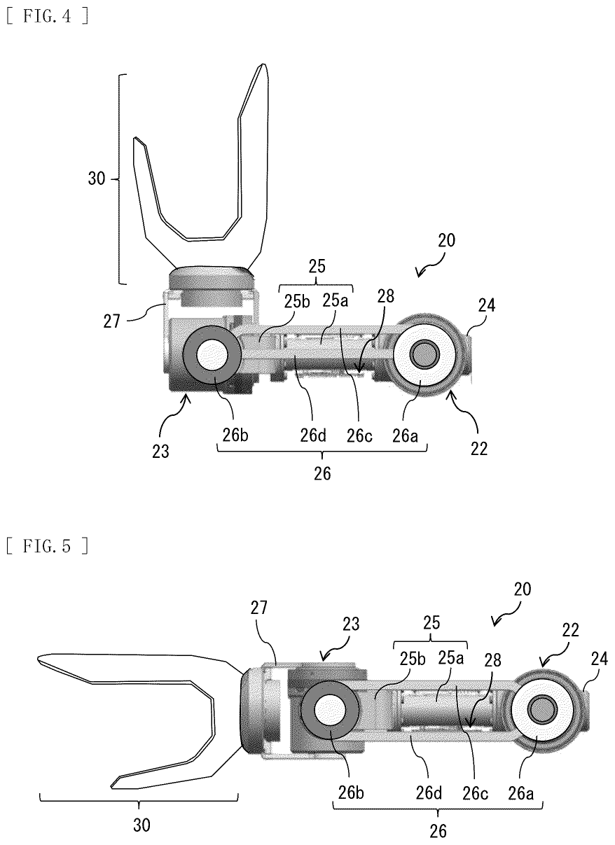

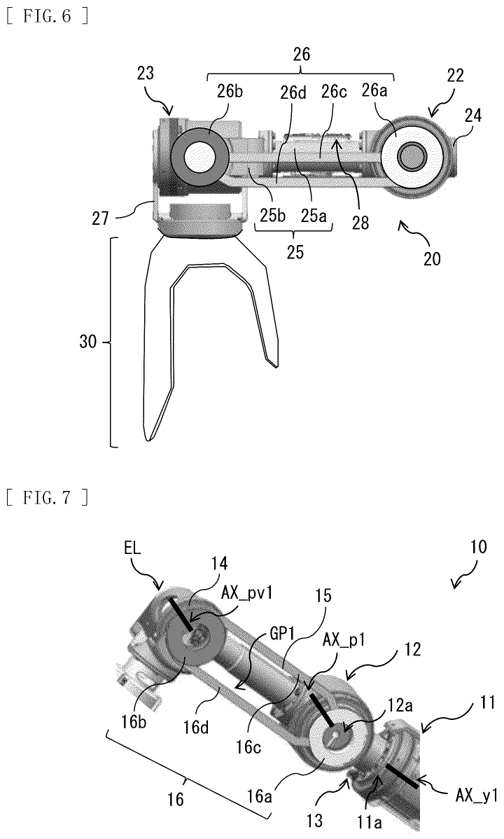

FIG. 2 illustrates a plane configuration example of the tip-wrist device 20. FIG. 3 illustrates an exploded perspective configuration example of the tip-wrist device 20. FIG. 4 illustrates a situation where the tip-wrist device 20 is caused to take a −90° posture. FIG. 5 illustrates a situation where the tip-wrist device 20 is caused to take a 0° posture. FIG. 6 illustrates a situation where the tip-wrist device 20 is caused to take a +90° posture. Note that the Yaw axis AX_y, the Pitch axis AX_p, the virtual Pitch axis AX_pv, and the Roll axis AX_y illustrated in FIGS. 2 to 6 are provided for purpose of description, and represent no actual axes.

The tip-wrist device 20 has a three-axis configuration where rotation axes are disposed in an order of the Yaw axis AX_y, the Pitch axis AX_p, and the Roll axis AX_y from the elbow section EL to the wrist section WR. Note herein that Yaw refers to a rotation around a center axis that is an axis parallel to a direction from the elbow section EL to the wrist section WR. The Yaw axis AX_y refers to a Yaw rotation axis, and, specifically, refers to a rotation axis of a Yaw actuator 21. Pitch refers to a rotation around a center axis that is an axis orthogonal to the Yaw axis AX_y. The Pitch axis AX_p refers to a Pitch rotation axis, and, specifically, refers to a rotation axis of a Pitch actuator 22 described later. Roll refers to a rotation around a center axis orthogonal to the Pitch axis AX_p. The Roll axis AX_y refers to a Roll rotation axis, and, specifically, refers to a rotation axis of a Roll actuator 23 described later.

The tip-wrist device 20 includes: the Yaw actuator 21 that uses the Yaw axis AX_y as its rotation axis; the Pitch actuator 22 that uses the Pitch axis AX_p as its rotation axis; and the Roll actuator 23 that uses the Roll axis AX_y as its rotation axis.

The Yaw actuator 21 is disposed at a position of the elbow section EL or adjacent to the elbow section EL, and includes a rotatable member (a rotating section 21a) that uses the Yaw axis AX_y as its rotation axis. The Roll actuator 23 is disposed at a position of the wrist section WR or adjacent to the wrist section WR, and includes a rotatable member (a rotating section 23a) that uses the Roll axis AX_y as its rotation axis. The Pitch actuator 22 is disposed at a position between the Yaw actuator 21 and the Roll actuator 23, and includes a rotatable member (a rotating section 22a) that uses the Pitch axis AX_p as its rotation axis.

The tip-wrist device 20 includes a coupler 24 that couples the Yaw actuator 21 and the Pitch actuator 22 to each other, a coupler 25 that couples the Pitch actuator 22 and the Roll actuator 23 to each other, and a torque transmitter 26. The tip-wrist device 20 includes a coupler 27 that couples the Roll actuator 23 and the hand device 30 to each other.

The coupler 24 is fixed to the rotating section 21a of the Yaw actuator 21, and causes, as the Yaw actuator 21 is driven, the Pitch actuator 22 to use, as its rotation axis, and rotate around the Yaw axis AX_y. The coupler 24 is disposed on the Yaw axis AX_y, and is fixed to the rotating section 21a on the Yaw axis AX_y, for example.

The coupler 27 is fixed to the rotating section 23a, and causes, as the Roll actuator 23 is driven, the hand device 30 to use, as its rotation axis, and rotate around the Roll axis AX_r. The coupler 27 is a U-shape member that pinches the Roll actuator 23 in directions that are parallel to the Roll axis AX_r and that is fixed to the rotating section 23a, for example.

The coupler 25 includes a support section 25b that supports the Roll actuator 23 to use, as its rotation axis, and to be rotatable around the virtual Pitch axis AX_pv that is parallel to the Pitch axis AX_p, as illustrated in FIGS. 1 to 3, for example. The virtual Pitch axis AX_pv is set at a location of intersection with the Roll axis AX_y, for example. The support section 25b is a U-shape member that pinches the Roll actuator 23 in directions that are parallel to the virtual Pitch axis AX_pv, for example. The coupler 25 further includes a fixing section 25a fixed to the support section 25b and a housing of the Pitch actuator 22, as illustrated in FIGS. 1 to 3, for example. The fixing section 25a is disposed on the Yaw axis AX_y, and fixed to the support section 25b and the housing of the Pitch actuator 22 on the Yaw axis AX_y, for example.

The torque transmitter 26 is a mechanism that causes, as the rotating section 22a of the Pitch actuator 22 rotates (as the Pitch actuator 22 is driven), torque that causes the Roll actuator 23 to use, as its rotation axis, and rotate around the virtual Pitch axis AX_pv to occur. The torque transmitter 26 is coupled to the Pitch actuator 22 and the Roll actuator 23, where a section (the Pitch actuator 22) where a force serving as a source of torque occurs and a section (the Roll actuator 23) where torque occurs differ from each other. That is, the tip-wrist device 20 is provided with the Pitch actuator 22 at a section that differs from a section where a Pitch movement actually occurs. The Pitch actuator 22 is disposed at a position adjacent to the elbow section EL, compared with the Roll actuator 23.

The torque transmitter 26 includes rotating sections 26a and 26b and couplers 26c and 26d, as illustrated in FIGS. 2 and 3, for example.

The rotating section 26a is fixed to the rotating section 22a of the Pitch actuator 22, and uses, as its rotation axis, and rotates around the Pitch axis AX_p, as the rotating section 22a rotates. The rotating section 26a has a disc shape or a ring shape, for example. The rotating section 26b is fixed to the fixing section 23b attached to a housing of the Roll actuator 23, and uses, as its rotation axis, and rotates around the virtual Pitch axis AX_pv, as the couplers 26c and 26d are displaced. The rotating section 26b has a disc shape or a ring shape, for example.

The couplers 26c and 26d are disposed at positions facing each other with a plane including the Pitch axis AX_p and the virtual Pitch axis AX_pv interposed (hereinafter referred to as a “virtual plane”.), respectively. That is, the couplers 26c and 26d are disposed at locations that are not in contact with the virtual plane, respectively. The couplers 26c and 26d extend along the virtual plane, and are coupled at a section that differs from a center of rotation on the rotating section 22a and a section that differs from a center of rotation on the rotating section 26b, respectively.

The couplers 26c and 26d are rigid thin metal plates, for example. Ends of the couplers 26c and 26d are pinched between the rotating section 22a and the rotating section 26a, and are rotatably coupled to the rotating section 22a and the rotating section 26a, respectively, for example. The ends of the couplers 26c and 26d are each provided with one protrusion on a side facing the rotating section 22a and one protrusion on a side facing the rotating section 26a, and the protrusions are in contact with the rotating section 22a and the rotating section 26a via bearings, respectively. The rotating section 26a is fixed to the rotating section 22a with a bolt.

Other ends of the couplers 26c and 26d are pinched between a rotating section 22b and the fixing section 23b, and are rotatably coupled to the rotating section 22b and the fixing section 23b, respectively, for example. The other ends of the couplers 26c and 26d are each provided with one protrusion on a side facing the rotating section 22b and one protrusion on a side facing the fixing section 23b, and the protrusions are in contact with the rotating section 22b and the fixing section 23b via bearings, respectively. The rotating section 26b is fixed to the fixing section 23b with a bolt.

The ends of the couplers 26c and 26d are fixed at positions where an angle of 45 degrees is formed between the virtual plane and a line segment coupling each of the ends of the couplers 26c and 26d and the Pitch axis AX_p, on the rotating section 22a and the rotating section 26a. The other ends of the couplers 26c and 26d are fixed at positions where an angle of 45 degrees is formed between the virtual plane and a line segment coupling each of the other ends of the couplers 26c and 26d and the Pitch axis AX_p, on the rotating section 22b and the fixing section 23b. Thereby, it is possible to secure an operating angle of +/−90 degrees or wider without allowing the couplers 26c and 26d to come into contact with each other.

Between the Pitch actuator 22 and the Roll actuator 23 in the tip-wrist device 20, there is a cavity GP around the couplers 25, 26c, and 26d. A driver substrate 28 that drives the Pitch actuator 22 and the Roll actuator 23 may be accommodated in the cavity GP, as illustrated in FIG. 3, for example. Note that, in a case where hollow structures are provided inside the Yaw actuator 21, the Pitch actuator 22, and the Roll actuator 23, various types of electric power supplies and signal wires, for example, may be disposed in the hollow structures.

As torque occurred in the torque transmitter 26 has caused a Pitch movement of the Roll actuator 23 to occur, the Pitch movement is transmitted to the hand device 20 via the coupler 27. As a result, the hand device 20 is displaced at an angle of −90° with respect to the tip-wrist device 20, as illustrated in FIG. 4, for example, displaced at an angle of 0° with respect to the tip-wrist device 20, as illustrated in FIG. 5, for example, or displaced at an angle of +90° with respect to the tip-wrist device 20, as illustrated in FIG. 6, for example.

Next, the elbow device 10 will now be described in detail with reference to FIG. 7. FIG. 7 illustrates a perspective configuration example of the elbow device 10.

The elbow device 10 includes: a Yaw actuator 11 that uses a Yaw axis AX_y1 as its rotation axis; a Pitch actuator 12 that uses a Pitch axis AX_p1 as its rotation axis; and an elbow-tip support section 14. The elbow-tip support section 14 is disposed on the elbow section EL, and is fixed to an end of the tip-wrist device 20 (a housing of the Yaw actuator 21).

The Yaw actuator 11 is disposed at a position adjacent to a base of the robot arm apparatus 1 (a shoulder of the robot device), and includes a rotatable member (the rotating section 21a) that uses the Yaw axis AX_y1 as its rotation axis. The Pitch actuator 12 is disposed at a position between the elbow-tip support section 14 and the Yaw actuator 11, and includes a rotatable member (a rotating section 12a) that uses the Pitch axis AX_p1 as its rotation axis.

The elbow device 10 includes a coupler 13 that couples the Yaw actuator 11 and the Pitch actuator 12 to each other, a coupler 15 that couples the Pitch actuator 12 and the elbow-tip support section 14 to each other, and a torque transmitter 16.

The coupler 13 is fixed to a rotating section 11a of the Yaw actuator 11, and causes, as the Yaw actuator 11 is driven, the Pitch actuator 12 to use, as its rotation axis, and rotate around the Yaw axis AX_y1. The coupler 13 is disposed on the Yaw axis AX_y1, and is fixed to the rotating section 11a on the Yaw axis AX_y1, for example.

The coupler 15 has a similar configuration to that of the coupler 25. The coupler 15 includes a support section that supports the elbow-tip support section 14 to use, as its rotation axis, and to be rotatable around a virtual Pitch axis AX_pv1 that is parallel to the Pitch axis AX_p1, for example. In the coupler 15, the support section is a U-shape member that pinches the elbow-tip support section 14 in directions that are parallel to the virtual Pitch axis AX_pv1, for example. The coupler 15 further includes a fixing section fixed to the support section and a housing of the Pitch actuator 12. In the coupler 15, the fixing section is disposed on the Yaw axis AX_y1, and is fixed to the support section and the housing of the Pitch actuator 12 on the Yaw axis AX_y1, for example.

The torque transmitter 16 is a mechanism that causes, as the rotating section 12a of the Pitch actuator 12 rotates, torque that causes the elbow-tip support section 14 to use, as its rotation axis, and rotate around the virtual Pitch axis AX_pv1 to occur. The torque transmitter 16 is coupled to the Pitch actuator 12 and the elbow-tip support section 14, where a section (the Pitch actuator 12) where a force serving as a source of torque occurs and a section (the elbow-tip support section 14) where torque occurs differ from each other. That is, the elbow device 10 is provided with the Pitch actuator 12 at a section that differs from a section where a Pitch movement actually occurs. The Pitch actuator 12 is disposed at a position adjacent to the base of the robot arm apparatus 1 (the shoulder of the robot device), compared with the elbow-tip support section 14.

The torque transmitter 16 includes rotating sections 16a and 16b and couplers 16c and 16d, as illustrated in FIG. 7, for example.

The rotating section 16a is fixed to the rotating section 12a of the Pitch actuator 12, and uses, as its rotation axis, and rotates around the Pitch axis AX_p1, as the rotating section 12a rotates. The rotating section 16a has a disc shape or a ring shape, for example. The rotating section 16b is fixed to a fixing section attached to a housing of the elbow-tip support section 14, and uses, as its rotation axis, and rotates around the virtual Pitch axis AX_pv1, as the couplers 16c and 16d are displaced. The rotating section 16b has a disc shape or a ring shape, for example.

The couplers 16c and 16d are disposed at positions facing each other with a plane including the Pitch axis AX_p1 and the virtual Pitch axis AX_pv1 interposed (hereinafter referred to as a “virtual plane”.), respectively. That is, the couplers 16c and 16d are disposed at locations that are not in contact with the virtual plane, respectively. The couplers 16c and 16d extend along the virtual plane, and are fixed at a section that differs from a center of rotation on the rotating section 12a and a section that differs from a center of rotation on the rotating section 16b, respectively.

The couplers 16c and 16d are rigid thin metal plates, for example. Ends of the couplers 16c and 16d are pinched between the rotating section 12a and the rotating section 16a, and are secured with a screw into the rotating sections 12a and 16a, respectively, for example. Other ends of the couplers 16c and 16d are pinched between the rotating section 12b and the fixing section of the elbow-tip support section 14, and are secured with a screw into the rotating section 12b and the fixing section of the elbow-tip support section 14, respectively, for example.

Between the Pitch actuator 12 and the elbow-tip support section 14 in the elbow device 10, there is a cavity GP1 around the couplers 15, 16c, and 16d. A driver substrate that drives the Pitch actuator 12 and the Yaw actuator 21 may be accommodated in the cavity GP1, for example. Note that, in a case where hollow structures are provided inside the Yaw actuator 11 and the Pitch actuator 12, various types of electric power supplies and signal wires, for example, may be disposed in the hollow structures.

Next, effects of the robot arm apparatus 1 will now be described herein.

In the present embodiment, as the Pitch actuator 22 provided between the Yaw actuator 21 and the Roll actuator 23 is driven, torque that causes the Roll actuator 23 to use, as its rotation axis, and rotate around the virtual Pitch axis AX_pv that is parallel to the Pitch axis AX_p is caused to occur. Thereby, it is possible to achieve such a compact device size that a collision in an ambient environment or with an object, for example, rarely occurs, compared with a case where the Pitch actuator 22 is disposed on the Roll axis AX_y. Furthermore, applying such a three-axis configuration makes it possible that the configuration rarely falls into such a singular posture that occurs in a case where a two-axis configuration such as a Yaw-Pitch-Yaw configuration is applied.

In the present embodiment, the Pitch actuator 22 provided between the Yaw actuator 21 and the Roll actuator 23 makes it possible to reduce dead-weight torque, compared with a case where the Pitch actuator 22 is disposed on the Roll axis AX_y. As a result, it is possible to increase weight capacity.

In the present embodiment, the coupler 25 including the support section 25b and the fixing section 25a is provided. Thereby, it is possible to efficiently cause torque that causes the Roll actuator 23 to use, as its rotation axis, and rotate around the virtual Pitch axis AX_pv to occur.

In the present embodiment, the torque transmitter 26 including the rotating sections 26a and 6b and the couplers 26c and 26d is provided. Thereby, it is possible to secure a wider operating angle without allowing the couplers 26c and 26d to come into contact with each other.

In the present embodiment, the driver substrate 28 is disposed in the cavity (the cavity GP) between the Pitch actuator 22 and the Roll actuator 23. Thereby, it is possible to achieve a compact device size, compared with a case where the driver substrate 28 is disposed inside the Pitch actuator 22 or the Roll actuator 23.

### 3. MODIFICATION EXAMPLES

Next, modification examples of the robot arm apparatus 1 will now be described herein.

In the embodiment described above, metallic wires may be used to form the couplers 26c and 26d. Furthermore, in the embodiment described above, a timing belt may be used to form the torque transmitter 26.

### 4. APPLICATION EXAMPLE

Next, a robot device 100 that uses the robot arm apparatuses 1 as manipulators will now be described herein. FIG. 8 illustrates a perspective configuration example of the robot device 100. The robot device 100 includes a main body 110, a moving mechanism 120, the two robot arm apparatuses 1, and a non-contact sensor 130.

The main body 110 includes, for example, a drive section and a control section for the robot device 100 to serve as a center section to which sections of the robot device 100 are attached. The control section controls those provided to the robot device 100 including the two robot arm apparatuses 1, the moving mechanism 120, and the non-contact sensor 130. The main body 110 may have a shape resembling an upper half of a human body having a head, a neck, and a torso.

The robot arm apparatuses 1 are, for example, multi-articulated type manipulators respectively attached to the main body 110. One of the robot arm apparatuses 1 is, for example, attached to a right shoulder of the main body 110 resembling the upper half of the human body. The other one of the robot arm apparatuses 1 is, for example, attached to a left shoulder of the main body 110 resembling the upper half of the human body.

The moving mechanism 120 is, for example, provided to a lower section of the main body 110 and is a section that allows the robot device 100 to move. The moving mechanism 120 may be a wheel type moving device having two or four wheels or a leg type moving device having two or four legs. Furthermore, the moving mechanism 120 may be a hover type, propeller type, or endless track type moving device.

The non-contact sensor 130 is, for example, a sensor that is provided to the main body 110 or another section and that detects (senses), in a non-contact manner, information relating to an ambient environment (an external environment) of the robot device 100. The non-contact sensor 130 outputs sensor data acquired through the detection (sensing). A non-contact sensor 40 is, for example, an imaging device such as a stereo camera, a monocular camera, a color camera, an infrared camera, or a polarization camera. Note that the non-contact sensor 130 may be an environment sensor that detects weather, meteorological, or other conditions, a microphone that detects sound, or a depth sensor such as an ultrasonic sensor, a time of flight (ToF) sensor, or a light detection and ranging (LiDAR) sensor. The non-contact sensor 130 may be a position sensor such as a global navigation satellite system (GNSS) sensor.

In the present application example, the robot arm apparatuses 1 are used as the manipulators in the robot device 100. Thereby, in a case where the robot device 100 is used as a life support device, for example, and a certain cup is handled among various types of eating utensils placed on a table, greater manipulability of a tip axis (a longer distance to a singular point) allows to acquire higher operability. Furthermore, an operation without greatly moving the upper arm becomes possible, and it is easily avoid a collision with something in an environment.

Furthermore, in a case where the robot device 100 is used as a life support device, it is necessary to not only perform a Pick-and-Place operation of an object, but also move an object with a restricted degree of freedom, such as a door knob is turned and a door of a microwave oven is opened and closed. Even in such a case as described above, a higher degree of freedom of the tip axis leads to a higher degree of freedom in operation, making it possible to acquire higher operability.

Although the present disclosure has been described with reference to the embodiment, the modification examples, and the application example, the present disclosure is not limited to thereto, but may be modified in a wide variety of ways. Note that the effects described in the specification are mere examples. The effects of the present disclosure are not limited to the effects described in the present specification. The present disclosure may include any other effects than those described herein.

Furthermore, for example, the present disclosure may have configurations described below.

(1)

A tip-wrist device including:
a first actuator that uses a Yaw axis as its rotation axis;
a second actuator that uses a Pitch axis as its rotation axis;
a third actuator that uses a Roll axis as its rotation axis; and
a torque transmitter,
in which
the first actuator, the second actuator, and the third actuator are disposed from an elbow side toward a hand side in this order,
the first actuator causes the second actuator to use, as its rotation axis, and rotate around the Yaw axis,
the third actuator causes a hand device to use, as its rotation axis, and rotate around the Roll axis, and
the torque transmitter causes, as the second actuator is driven, torque to occur that causes the third actuator to use, as its rotation axis, and rotate around a virtual axis that is parallel to the Pitch axis.
   (2)

The tip-wrist device according to (1), further including:
a support section that supports and causes the third actuator to use, as its rotation axis, and to be rotatable around the virtual axis; and
a fixing section that is fixed to the support section and a housing of the second actuator.
   (3)

The tip-wrist device according to (1) or (2), in which the torque transmitter includes:
a first rotating section fixed to a rotating section of the second actuator;
a second rotating section fixed to a housing of the third actuator; and
a first coupler and a second coupler disposed at positions facing each other with a virtual plane including the Pitch axis and the virtual axis interposed, respectively, the first coupler and the second coupler each having an end rotatably coupled to the first rotating section and another end rotatably coupled to the second rotating section.
   (4)

The tip-wrist device according to any one of (1) to (3), further including a driver substrate that is disposed in a cavity between the second actuator and the third actuator and drives the second actuator and the third actuator.

(5)

A robot arm apparatus that includes a tip-wrist device, the tip-wrist device including:
a first actuator that uses a Yaw axis as its rotation axis;
a second actuator that uses a Pitch axis as its rotation axis;
a third actuator that uses a Roll axis as its rotation axis; and
a torque transmitter,
in which
the first actuator, the second actuator, and the third actuator are disposed from an elbow side toward a hand side in this order,
the first actuator causes the second actuator to use, as its rotation axis, and rotate around the Yaw axis,
the third actuator causes a hand device to use, as its rotation axis, and rotate around the Roll axis, and
the torque transmitter causes, as the second actuator is driven, torque to occur that causes the third actuator to use, as its rotation axis, and rotate around a virtual axis that is parallel to the Pitch axis.

As the second actuator provided between the first actuator and the third actuator is driven in the tip-wrist device and the robot arm apparatus according to the embodiment of the present disclosure, torque that causes the third actuator to use, as its rotation axis, and rotate around a virtual axis that is parallel to the Pitch axis is caused to occur. Thereby, a compact device size is achieved, compared with a case where the second actuator is disposed on the Roll axis. Furthermore, applying such a three-axis configuration makes it possible that such a singular point that occurs in a case where a two-axis configuration such as a Yaw-Pitch-Yaw configuration is applied rarely occurs. Therefore, it is possible to provide a tip-wrist device and a robot arm apparatus each having such a compact configuration that rarely falls into a singular posture.

This application claims the benefit of Japanese Priority Patent Application JP 2021-176940 filed on Oct. 28, 2021, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. A tip-wrist device comprising:
a first actuator that uses a Yaw axis as its rotation axis;
a second actuator that uses a Pitch axis as its rotation axis;
a third actuator that uses a Roll axis as its rotation axis; and
a torque transmitter,
wherein
the first actuator, the second actuator, and the third actuator are disposed from an elbow side toward a hand side in this order,
the first actuator causes the second actuator to use, as its rotation axis, and rotate around the Yaw axis,
the third actuator causes a hand device to use, as its rotation axis, and rotate around the Roll axis, and
the torque transmitter causes, as the second actuator is driven, torque that causes the third actuator to use, as its rotation axis, and rotate around a virtual axis that is parallel to the Pitch axis to occur.

2. The tip-wrist device according to claim 1, further comprising:
a support section that supports and causes the third actuator to use, as its rotation axis, and to be rotatable around the virtual axis; and
a fixing section that is fixed to the support section and a housing of the second actuator.

3. The tip-wrist device according to claim 1, wherein the torque transmitter includes:
a first rotating section fixed to a rotating section of the second actuator;
a second rotating section fixed to a housing of the third actuator; and
a first coupler and a second coupler disposed at positions facing each other with a virtual plane including the Pitch axis and the virtual axis interposed, respectively, the first coupler and the second coupler each having an end rotatably coupled to the first rotating section and another end rotatably coupled to the second rotating section.

4. The tip-wrist device according to claim 1, further comprising a driver substrate that is disposed in a cavity between the second actuator and the third actuator and drives the second actuator and the third actuator.

5. A robot arm apparatus that includes a tip-wrist device, the tip-wrist device comprising:
a first actuator that uses a Yaw axis as its rotation axis;
a second actuator that uses a Pitch axis as its rotation axis;
a third actuator that uses a Roll axis as its rotation axis; and
a torque transmitter,
wherein
the first actuator, the second actuator, and the third actuator are disposed from an elbow side toward a hand side in this order,
the first actuator causes the second actuator to use, as its rotation axis, and rotate around the Yaw axis,
the third actuator causes a hand device to use, as its rotation axis, and rotate around the Roll axis, and
the torque transmitter causes, as the second actuator is driven, torque that causes the third actuator to use, as its rotation axis, and rotate around a virtual axis that is parallel to the Pitch axis to occur.
